(19) United States
(12) Patent Application Publication
(10) Pub. No.: US 2013/0167647 A1
(43) Pub. Date: Jul. 4, 2013

(54) Concurrent Multiple Characteristic Ultrasonic Inspection

(71) Applicant: General Electric Company, Schenectady, NY (US)

(72) Inventors: Mark Samuel Bailey, Fairfield, OH (US); Matthew Foister, West Chester, OH (US); Johannah Itescu, Hamburg (DE)

(73) Assignee: General Electric Company, Schenectady, NY (US)

(21) Appl. No.: 13/716,325

(22) Filed: Dec. 17, 2012

Related U.S. Application Data
(60) Provisional application No. 61/581,785, filed on Dec. 30, 2011.

(51) Int. Cl. G01N 29/28; G01N 29/22

(52) U.S. Cl. CPC G01N 29/28; G01N 29/22
USPC 73/644; 73/632

(57) ABSTRACT

A method for acoustically measuring an external surface of a component and a wall thickness or component thickness at that location is provided. The method also provides for measuring the external surface by physical contact while concurrently acoustically measuring a wall thickness at that location.

### CROSS-REFERENCE TO RELATED APPLICATIONS

This application claims priority to and benefit under 35 U.S.C. §119(e) to U.S. Provisional Patent Application Ser. No. 61/581,785, filed on Dec. 30, 2011, the entire contents of which is herein incorporated.

### BACKGROUND

The disclosed embodiments generally pertain to the inspection of cast structures and particularly to the concurrent inspection of multiple characteristics therein.

### SUMMARY

One embodiment of the present invention provides a method for concurrently measuring and determining multiple characteristics of components. The method provides a component which is solid or includes one or more cavities therein, and an acoustic transceiver. The transceiver and component are provided in a known coordinate system. The method provides for the acoustic transceiver to emit an acoustic signal and concurrently receive a first and a second return signals. The method further provides for collecting these measurements at multiple given locations within the known coordinate system to form a three-dimensional model of the component wherein the component may be solid, hollow or a combination of such areas.

Another embodiment provides for an acoustic transceiver to physically touch a component to determine an absolute location on a point of an external surface of the component. Concurrently with touching the component, the transceiver also emits an acoustic signal and concurrently receives a return signal to determine a wall thickness at the point on the external surface of the component. These measurements may be made at multiple given locations within a known coordinate system to form a three-dimensional model of the component.

Another aspect provides for relative movement, such as translational movement, between the acoustic transceiver and the component.

Another embodiment provides an acoustic propagation medium or acoustic couplant in intimate contact between both the acoustic transceiver and the component.

Yet another aspect provides for the acoustic transceiver to be an ultrasonic transceiver.

Another aspect provides for a determination of the acoustic speed of the component material prior to acoustically measuring the component thickness or wall thickness of the component.

### BRIEF DESCRIPTION OF THE ILLUSTRATIONS

Embodiments of the invention are illustrated in the following illustrations.

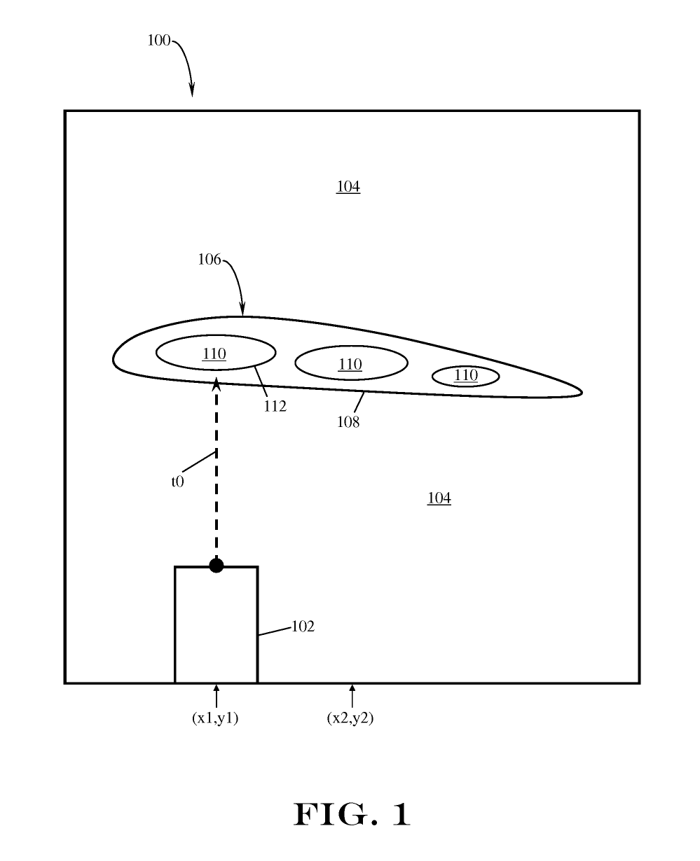

FIG. 1 is a schematic representation of an ultrasonic transmission through a component at a first location within a known coordinate system.

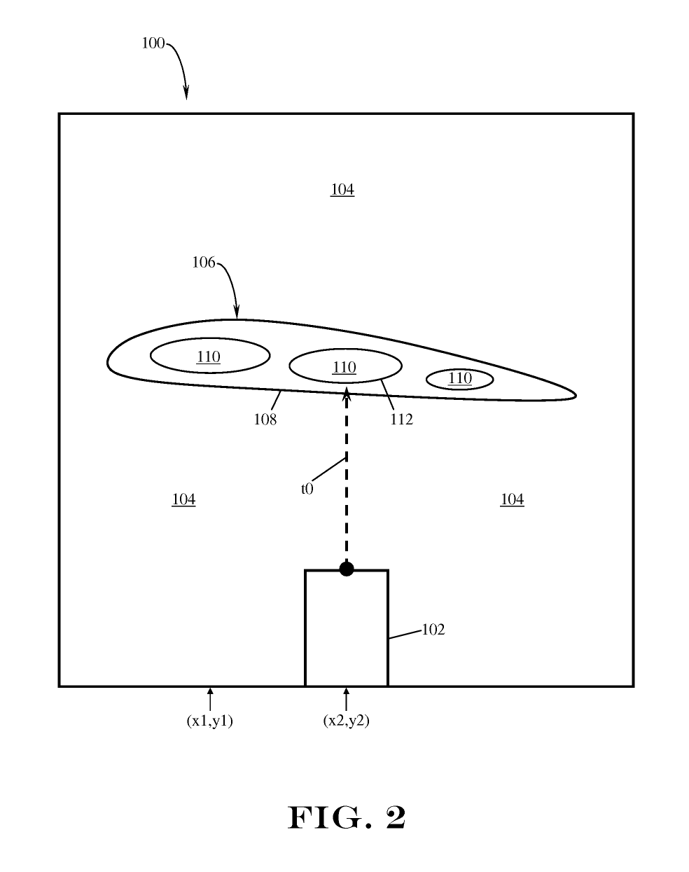

FIG. 2 is a schematic representation of an ultrasonic transmission through a component at a second location within a known coordinate system.

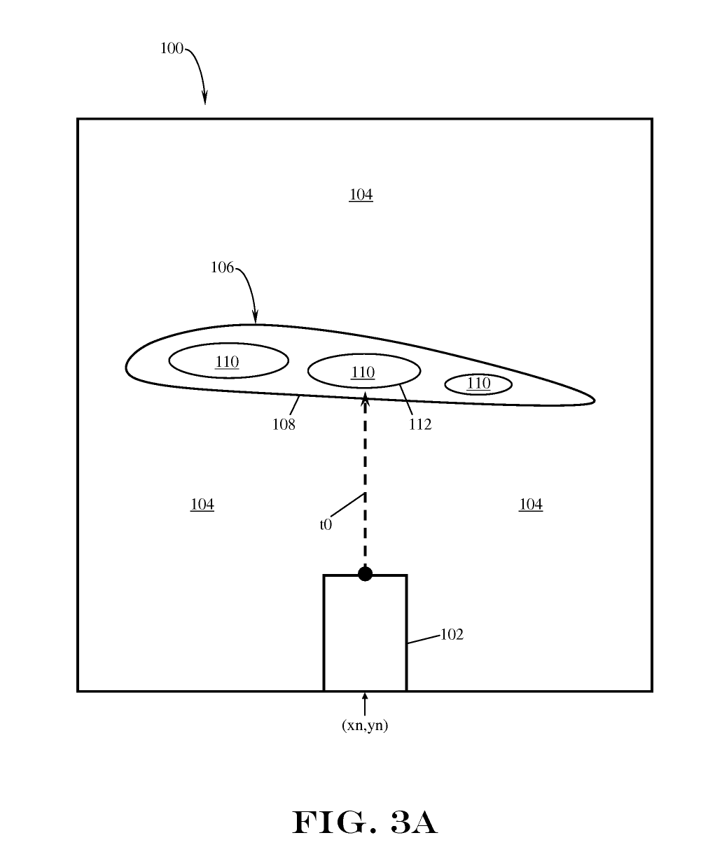

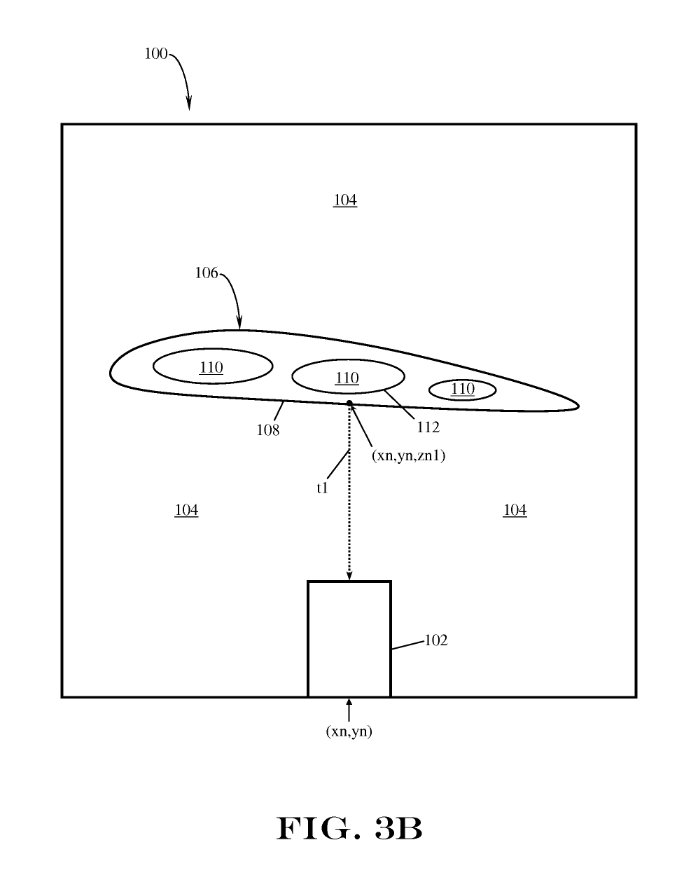

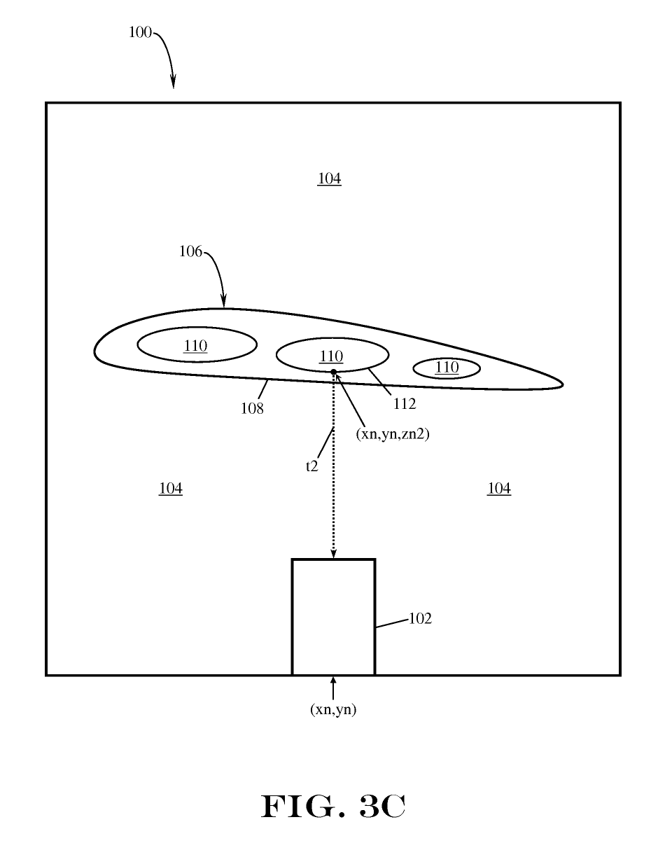

FIGS. 3A-3C are schematic representations of a concurrent ultrasonic measurement of a point on an external surface and a wall thickness at that point within a known coordinate system.

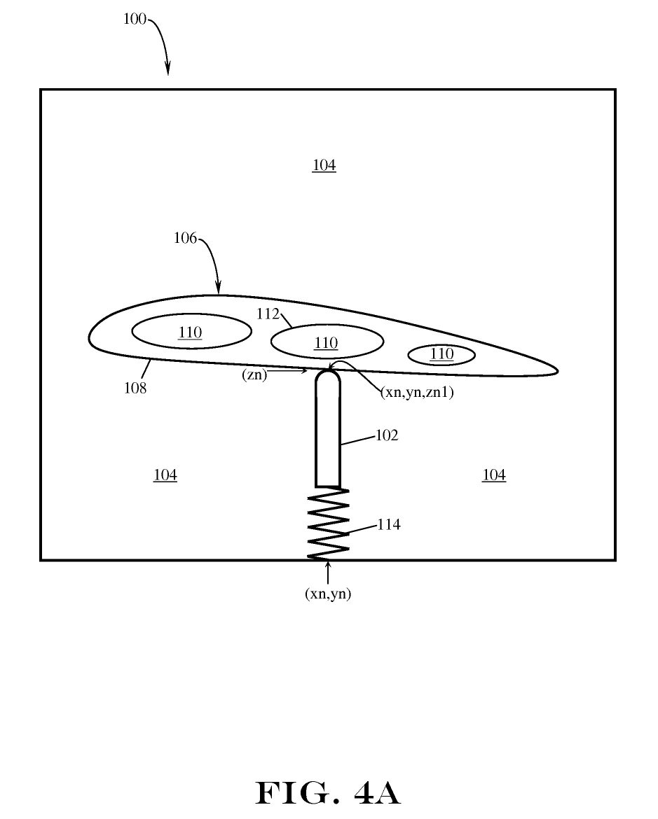

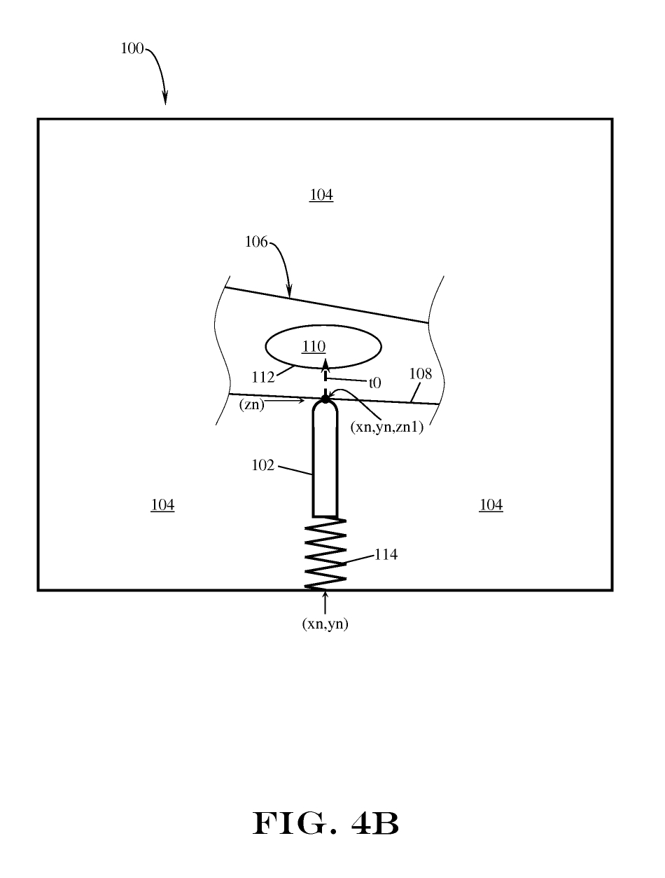

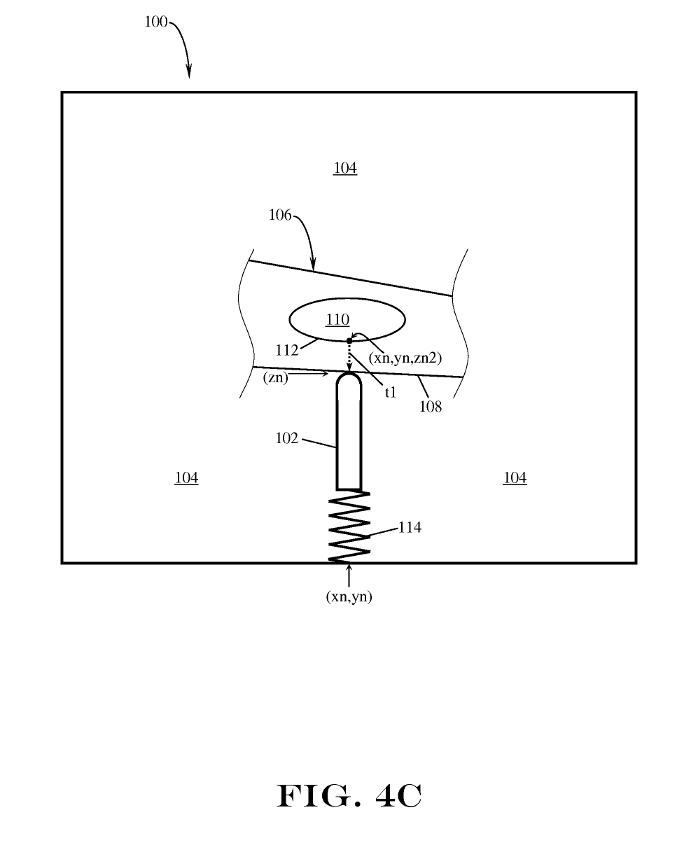

FIGS. 4A-4C are schematic representations of a physical measurement of a point on an external surface and a concurrent ultrasonic measurement of a wall thickness at that point within a known coordinate system.

### DETAILED DESCRIPTION

Referring now to FIGS. 1 and 2, a system 100 for concurrent ultrasonic measurement of a component 106 is provided. The system 100 is provided with an acoustic transceiver 102. The acoustic transceiver 102 may be an ultrasonic transceiver 102, and may optionally be provided as separate components of an acoustic transmitter and a separate acoustic receiver. The transceiver 102 transmits and receives radio and electrical signals, such as ultrasonic signals, at a known speed. The system 100 is further provided with an acoustic couplant or propagation medium 104 having a known acoustic speed, which is typically measured in units of mm/μs through which the ultrasonic signal may pass. The acoustic couplant 104 may be, for example, water. However, other known couplants may be used, such as, for example, propylene glycol, glycerin, silicone oil, and acoustic gels.

A component 106, such as, for example, a cast airfoil as used in gas turbine engines, is provided for measurement. The component 106 is provided with at least one external surface 108 and may be provided with one or more internal cavities 110. According to some embodiments, the component 106 may be a solid component with a first external surface and a second external surface. Other embodiments may include components 106 with a combination of solid areas and hollows areas. The internal cavities 110 are also provided with at least one surface 112 associated therewith that is internal to the component 106. The component 106 may also be provided with one or more datums to ensure proper placement of the component 106 within the system 100.

The component 106 is preferably made of a material having a known acoustic speed, which is typically measured in units of mm/μs. For components 106 that are made of a material having a single crystal composition, the crystal orientation may be determined prior to the acoustic testing methods disclosed herein. The crystal orientation relative to the emitted acoustic signal and return signal(s) (described herein) may impact the accuracy of the acoustic measurements, as the acoustic speed may vary depending on this orientation. Therefore prior to testing, the orientation may be determined by x-ray, for example. However, other methods of determining this orientation may also be utilized.

The acoustic couplant 104 is provided in intimate contact with both the acoustic transceiver 102 and the component 106. One method for providing such intimate contact is to submerse both the transceiver 102 and the component 106 within the acoustic couplant 104. However, other methods for providing this intimate contact may be utilized, such as, for example, providing a flow of the couplant 104 between the transceiver 102 and component 106 through which the acoustic signal is transmitted and received.

The acoustic transceiver 102 may be provided at a known position or location (x1,y1), (x2,y2) within a known two-dimensional coordinate system. For example, the x and y dimensions of the depicted embodiments include the left-right direction and into-out of the page. A third dimension is up and down in the depicted embodiment, for example, as described further herein. The system 100 may provide for relative movement between the transceiver 102 and the component 106. For instance, and as shown between FIGS. 1 and 2, the transceiver 102 may move through the coordinate system relative to the component 106 in two dimensions, for example, the x and y directions. Alternatively, the component 106 may move instead of or in addition to the movement of the transceiver 102. The movement of either the transceiver 102 or component 106 may be translational movement. The relative movement between the transceiver 102 and component 106 may be accomplished by any one of a variety of known means, such as, for example, with a linear motor. The motor may also be coupled to a linear variable differential transducer (LVDT) for determining the location of the transceiver 102 relative to the component within the known coordinate system.

The known location of the transceiver 102 within the known two-dimensional coordinate system is coupled with the measurements taken by the transceiver 102 to create a three-dimensional model of the component 106. With the transceiver 102 at a first location (x1,y1), the transceiver 102 emits an acoustic signal, represented by the dashed arrow t0, toward the component 106. The emitted acoustic signal t0 may be various sonic signals including, for example, an ultrasonic signal. The transceiver 102 may emit the acoustic signal at a first location (x1,y1), at a second location (x2,y2), and at any number of subsequent locations (xn,yn) within the known two-dimensional coordinate system.

Referring now to FIGS. 3A-3C, the transceiver 102 emits an acoustic signal t0 at a given location (xn,yn) within a known two-dimensional coordinate system. The transceiver 102 may then receive a first acoustic return signal, represented by dotted line t1, from the component external surface 108, and concurrently receive a second acoustic return signal, represented by dotted line t2, from the component internal surface 112.

Knowing the acoustic speed of the acoustic couplant 104 and by recording the time lag between sending the transmitted acoustic signal t0 and receiving the first return signal t1, one can determine an absolute coordinate of a point on the external surface 108 of the component 106. Combining this measurement with the known location of the transceiver 102 within the known two-dimensional coordinate system, one can then determine a measured external point (xn,yn,zn1) on the external surface 108 relative to the known coordinate system.

Further, knowing the acoustic speed of the cast material of the component 106 and by recording the time lag between receiving the first return signal t1 and receiving the second return signal t2, one can determine a wall thickness of the component 106. Knowing this thickness, the measured external point (xn,yn,zn1) on the external surface 108, and the position of the transceiver 102 within the known two-dimensional coordinate system, one can then determine a measured internal point (xn,yn,zn2) on the internal surface 112 relative to the known coordinate system.

Given the external absolute position in space and the relative wall thickness for selected locations and by repeating these steps over multiple positions (x1,y1), (x2,y2), (xn,yn) within the known two-dimensional coordinate system, one can develop a three-dimensional model of the entire component 106. The time measurements and the required calculations for developing the three-dimensional model may be recorded and performed via computer software.

In the case of a solid component, such as a fan blade for example, without hollow portions or a solid portion of a combination hollow and solid component, the transceiver 102 emits an acoustic signal t0 at a given location (xn,yn) within a known two-dimensional coordinate system. The dotted line t2 would extend to the opposite external surface. The opposite external surface may be unitary with the first external surface or may be formed by a second piece of material from the first material. These may be the same or different materials. The transceiver 102 may then receive a first acoustic return signal, represented by dotted line t1, from the component external surface 108, and concurrently receive a second acoustic return signal, represented by dotted line t2, from the opposite external surface of the component 106.

Knowing the acoustic speed of the acoustic couplant 104 and by recording the time lag between sending the transmitted acoustic signal t0 and receiving the first return signal t1, one can determine an absolute coordinate of a point on the external surface 108 of the component 106. Combining this measurement with the known location of the transceiver 102 within the known two-dimensional coordinate system, one can then determine a measured external point (xn,yn,zn1) on the external surface 108 relative to the known coordinate system.

Further, knowing the acoustic speed of the cast material of the component 106 and by recording the time lag between receiving the first return signal t1 and receiving the second return signal t2, the thickness of an exemplary solid component 106 or solid portion of component 106. Knowing this thickness, the measured external point (xn,yn,zn1) on the external surface 108, and the position of the transceiver 102 within the known two-dimensional coordinate system, one can then determine a second external point (xn,yn,zn2) on the opposite external surface relative to the known coordinate system.

Given the external absolute position in space and the relative component thickness for selected locations and by repeating these steps over multiple positions (x1,y1), (x2,y2), (xn,yn) within the known two-dimensional coordinate system, one can develop a three-dimensional model of the entire component 106. The time measurements and the required calculations for developing the three-dimensional model may be recorded and performed via computer software.

Referring now to FIGS. 4A-4C, an acoustic transceiver 102 may be combined as a probe to both physically contact and acoustically penetrate the component 106 to determine a three-dimensional model of a component 106. The transceiver 102 may be provided on an apparatus having a spring component coupled to a LVDT 114 for allowing and measuring translational movement. Other known biasing devices that accommodate for compliant movement may also be used besides a spring. Also, other known devices for measuring translational movement besides a LVDT may be utilized. The transceiver 102 and component 106 are presented to one another at given location (xn,yn) within a known two-dimensional coordinate system. The tip of the transceiver 102 and the component 106 may then be brought into contact with one another at a predetermined nominal height (zn).

To determine an absolute three-dimensional model, the system may start with a working three-dimensional model based on what the component should be from its manufacturing process. This model determines an expected nominal height (zn) at a given location (xn,yn) of a component 106. Therefore at a given location (xn,yn) in a known coordinate system, the transceiver 102 and component 106 will be brought together at the expected nominal height (zn). Any variance in this height (zn) will translate the transceiver 102 relative to the component via the spring/LVDT apparatus 114. The spring/LVDT apparatus 114 can measure this translational movement relative to the expected nominal height (zn) and an absolute measured height (zn1) can be determined at the given location (xn,yn) within the known coordinate system. Thus, a measured external point (xn,yn,zn1) can now be determined on the component external surface 108.

Referring to FIG. 4B with the transceiver 102 and component 106 in contact, the transceiver 102 emits an acoustic signal t0 into the component 106 in order to measure a wall thickness at the measured external point (xn,yn,zn1). Referring to FIG. 4C, the transceiver 102 receives a return signal t1 from the internal surface 112. Knowing the acoustic speed of the component 106 and the time lag between the emitted signal t0 and the received return signal t1, one can determine a wall thickness at the measured external point (xn,yn,zn1) and thus determine a measured internal point (xn,yn,zn2) on the internal surface 112.

The method shown in FIGS. 4A-4C may be repeated over multiple locations to develop a three-dimensional model of the entire component 106, be it solid, hollow or a component with both solid and hollow components. The time measurements and the required calculations for developing the three-dimensional model may be recorded and performed via computer software.

The three-dimensional model may be created concurrently with the measurements taken and may be performed via computer software. The three-dimensional model may subsequently be used to determine the optimal manufacturing sequence for machining critical features onto the specific component 106. Any casting variation within the component 106 that may require a variance in machining and/or result in performance variation of the component is minimized. Such variances may include a core shift, a core tilt, or a combination thereof. Alternatively, similar families of castings may be measured as opposed to modeling each individual component 106.

The calculated three dimensional model of the component 106 may then be utilized in later machining processes performed on that component 106, such as determining where to drill holes and how deep to drill them in order not to damage the internal cavities 110 on internal surfaces of walls. For instance, each component 106 may be uniquely machined according to casting variances unique to that component 106 or unique to a group of components. By being able to tailor the machining processes to each component 106, manufacturing losses, such as scrap and rework, may be reduced. The data gathered by the methods disclosed herein may also provide feedback to the casting process from which the component 106 was manufactured.

The foregoing written description of structures and methods has been presented for purposes of illustration. Examples are used to disclose the invention, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for measuring components comprising the steps of:
providing a component having at least one first surface and at least one second surface;
providing an acoustic transceiver;
providing said acoustic transceiver and said component within a known coordinate system;
said acoustic transceiver concurrently emitting an acoustic signal at a first location within said known coordinate system toward said component, concurrently receiving a first return signal from said at least one first surface, and concurrently receiving a second return signal from said at least one second surface;
recording a first time lag between said emitting an acoustic signal and receiving said first return signal, and determining a measured first point on said at least one first surface within said known coordinate system;
recording a second time lag between said receiving said first return signal and said receiving said second return signal, and determining a measured second point on said at least one second surface within said known coordinate system; and
repeating said determining a measured first point step and said determining a measured second point step at multiple locations within said known coordinate system to create a three-dimensional model of said component.

2. The method of claim 1, wherein said second surface is one of an internal or external surface and said second point is one of internal or external to said component.

3. The method of claim 1, wherein said second surface is an internal surface, said second point is an internal point and said model includes internal cavities of said component.

4. The method of claim 1, wherein said acoustic transceiver is an ultrasonic transceiver.

5. The method of claim 4, linearly moving said ultrasonic transceiver.

6. The method of claim 1, wherein said component is machined based upon the calculated three-dimensional model.

7. The method of claim 1, wherein an acoustic couplant having a known acoustic speed is in intimate contact with both of said component and said transceiver.

8. The method of claim 7, indicating varying geometry of said at least one external surface by a length of said couplant stream.

9. The method of claim 7, wherein said component is of a material that has a known acoustic speed.

10. The method of claim 9, wherein said couplant is one of water propylene glycol, glycerin, silicone oil, and acoustic gels.

11. The method of claim 1 further comprising the step of:
providing relative motion between said acoustic transceiver and said component within said known coordinate system.

12. The method of claim 1, containing said acoustic transceiver with said component.

13. The method of claim 12, biasing said acoustic transceiver to accommodate varying geometry of said at least one external surface.

14. The method of claim 1, spacing apart said acoustic transceiver from said component.

15. A method for measuring components comprising the steps of:
providing a component having at least one external surface, one or more internal cavities therein, and having at least one internal surface associated with said one or more internal cavities;
providing an acoustic transceiver;
providing said acoustic transceiver and said component within a known coordinate system;
said acoustic transceiver touching said at least one external surface at a first location within said known coordinate system and measuring a height on said at least one external surface to determine a measured external point on said at least one external surface within said known coordinate system;
concurrently with touching said at least one external surface, said acoustic transceiver emitting an acoustic signal at said first location into said component and concurrently receiving a return signal from said at least one internal surface;
recording a time lag between said emitting an acoustic signal and receiving said return signal, and determining a measured internal point on said at least one internal surface within said known coordinate system; and
repeating said determining a measured external point step and said determining a measured internal point step at multiple locations within said known coordinate system to create a three-dimensional model of said component

16. A method of acoustically measuring a component having internal cores, comprising:
positioning a component within a known coordinate system, said component having at least one external surface, one or more internal cavities and at least one internal surface defining said one or more cavities;
positioning an acoustic transceiver adjacent to said component and within said known coordinate system;
emitting a first acoustic signal from said acoustic transceiver at a first location of said known coordinate system;
receiving a first return signal from said at least one external surface;
receiving a first time differential between said emitting and said receiving to determine an external location.
receiving a second return signal from said at least one internal surface;
recording a second time differential between said first return signal and said second return signal to determine an internal location within said component;
positioning said acoustic transceiver at a second location.

17. The method of claim 16, touching said acoustic transceiver and said external surface.

18. The method of claim 16, spacing apart said acoustic transceiver and said external surface.

19. The method of claim 16 further comprising utilizing a stream of couplant.

20. The method of claim 16 further comprising submerging said component in a couplant.
